(19) United States
(12) Patent Application Publication
(10) Pub. No.: US 2013/0233018 A1
(43) Pub. Date: Sep. 12, 2013

(54) METHOD OF MANUFACTURING POROUS GLASS

(71) Applicants: Kenji Takashima, Tokyo (JP); Zuyi Zhang, Yokohama-shi (JP); Yoshinori Kotani, Yokohama-shi (JP); Akira Sugiyama, Yokohama-shi (JP); Naoyuki Koketsu, Kawasaki-shi (JP)

(72) Inventors: Kenji Takashima, Tokyo (JP); Zuyi Zhang, Yokohama-shi (JP); Yoshinori Kotani, Yokohama-shi (JP); Akira Sugiyama, Yokohama-shi (JP); Naoyuki Koketsu, Kawasaki-shi (JP)

(73) Assignee: CANON KABUSHIKI KAISHA, Tokyo (JP)

(21) Appl. No.: 13/884,674

(22) PCT Filed: Nov. 25, 2011
(86) PCT No.: PCT/JP2011/077877

§ 371 Date: May 10, 2013

(30) Foreign Application Priority Data
Nov. 30, 2010 (JP) 2010-266327
Nov. 18, 2011 (JP) 2011-253073

(51) Int. Cl. C03C 11/00

(52) U.S. Cl. CPC C03C 11/005
USPC 65/30.13

(57) ABSTRACT

To provide a method of manufacturing a porous glass in which the porosity decreases as a function of the distance from the surface in the direction of depth. A method of manufacturing a porous glass includes a step of bringing one or more than one ion species selected from silver ion, potassium ion and lithium ion into contact with a matrix glass containing borosilicate glass as main ingredient and heating the matrix glass to form a glass body having an ion concentration distribution with a concentration of the one or more than one ion species decreasing as a function of a distance from a surface in a direction of depth, a step of heating and phase-separating the glass body to form a phase-separated glass, and a step of etching the phase-separated glass to form a porous glass having a porosity decreasing as the function of the distance from the surface in the direction of depth.

### TECHNICAL FIELD

The present invention relates to a method of manufacturing a porous glass.

### BACKGROUND ART

Methods of relatively easily manufacturing porous glass by utilizing the phenomenon of phase separation are known. Borosilicate glass containing silica, boron oxide, and sodium oxide and so on as components is popularly being employed as matrix material for manufacturing porous glass by utilizing the phenomenon of glass separation. A molded piece of borosilicate glass is subjected to a heat treatment of holding the borosilicate glass at a constant temperature to give rise to a phenomenon of phase separation (to be referred to as a phase separation process hereafter) and the non-silica-rich phase is eluted by etching, using an acid solution, to manufacture porous glass. The skeleton of porous glass is mainly silica. The skeletal diameter, the pore diameter and the porosity of porous glass obtained in this way are influenced to a large extent by the composition before the phase separation process, and the temperature and the duration of the phase separation process. Furthermore, the skeleton, the pore diameter and the ratio of porous glass influence the reflectance and the refractive index of porous glass.

In the case of ordinary silica glass, the influence of air increases as the porosity rises and silica glass becomes a low refractive index material as a whole. A technique of forming a sub-wavelength structure as means for obtaining an excellent low reflection/anti-reflection performance is known. For example, take an instance of an ideal film having a sub-wavelength structure and formed on a substrate (the substrate and the film having a same refractive index) and assume that the film is divided into layers. Then, the space occupancy ratio of the layers continuously changes from 0% to 100% as viewed from the air toward the substrate and the effective refractive index continuously changes from the refractive index of air to the refractive index of the substrate. Due to these facts, reflection at the interfaces of the layers is minimized to achieve an excellent anti-reflection performance in terms of wavelength band characteristic and incident angle characteristic. In short, a porous glass material whose refractive index changes from the surface in the direction of depth and hence whose porosity decreases in that direction is required to obtain a glass having an excellent anti-reflection performance.

For example, PTL 1 discloses a technique of inducing a phenomenon of phase separation near a silica surface by applying a phase separation ingredient to be made to react with silica (SiO₂) onto a glass surface and heat-treating that. However, this technique is for producing undulations on the outmost surface of glass for tight adhesion of a plating layer. Therefore, this technique can neither induce a phase separation phenomenon at a depth sufficient for producing an anti-reflection function nor make the porous structure vary in terms of porosity among others.

PTL 2 discloses a technique of gradually changing the refractive index from a glass surface in the direction of depth by causing a compositional change to take place from the glass surface in the direction of depth by means of ion exchange. However, this technique is aimed at ion diffusion at depth not smaller than 5 mm from the surface and hence can hardly control ion diffusion only in a range not greater than several hundred μm. Additionally, since ions that are used in an ion exchange process influence the physical properties of the final product, ion exchanges that are conducted among limited ions can hardly provide general applicability. Furthermore, this technique requires high temperatures not lower than 1,300° C. and hence is costly.

PTL 3 discloses a treatment technique for changing the composition of glass that is made porous in advance from the glass surface in the direction of depth by means of an ion exchange process. However, the porous skeleton part needs to be made to contain the target element of ion exchange to a certain extent and hence this technique cannot apply to porous glass that is formed mainly from silica glass. Additionally, ions that are introduced by way of an ion exchange process are limited and containing the element can optically influence the final product and hence is inadequate.

NPL 1 discloses a method of manufacturing porous glass by using an ion exchange process and phase separation. However, since the proposed method employs glass that is subjected to phase separation in advance, the scope of skeleton, pore diameter and porosity that can be controlled in the process of producing porous glass is limited.

### CITATION LIST

### Patent Literature

PTL 1: Japanese Patent Application Laid-Open No. H01-317135

PTL 2: Japanese Patent Application Laid-Open No. 562-041725

PTL 3: Japanese Patent Application Laid-Open No. H06-345446

### Non Patent Literature

NPL 1: A. Flugel, C. Russel, Glasstech. Ber. Glass Sci. Technol., 73(2000) No. 7, p.204-210

### SUMMARY OF INVENTION

### Technical Problem

In view of the above-identified problems, the present invention is made to provide a method of manufacturing a porous glass having a porous structure that is made to vary from the surface in the direction of depth, particularly in which the porosity decreases as a function of the distance from the surface in the direction of depth.

### Solution to Problem

The above problems are solved by providing a method of manufacturing a porous glass including: a step of bringing one or more than one ion species selected from silver ion, potassium ion and lithium ion into contact with a matrix glass containing borosilicate glass as main ingredient and heating the matrix glass to form a glass body having an ion concentration distribution with a concentration of the one or more than one ion species decreasing as a function of a distance from a surface in a direction of depth; a step of heating and phase-separating the glass body to form a phase-separated glass; and a step of etching the phase-separated glass to form a porous glass having a porosity decreasing as the function of the distance from the surface in the direction of depth.

Further, the above problems are solved by providing a method of manufacturing a porous glass including: a step of bringing one or more than one ion species selected from silver ion, potassium ion and lithium ion into contact with a matrix glass containing borosilicate glass as main ingredient and heating the matrix glass to form an ion concentration distribution with a concentration of the one or more than one ion species decreasing as a function of a distance from a surface in a direction of depth and to form a phase-separated glass by phase separating; and a step of etching the phase-separated glass to form a porous glass having a porosity decreasing as the function of the distance from the surface in the direction of depth.

### Advantageous Effects of Invention

Thus, the present invention provides a method of manufacturing a porous glass having a porous structure that is made to vary from the surface in the direction of depth, particularly in which the porosity decreases as a function of the distance from the surface in the direction of depth.

Further features of the present invention will become apparent from the following description of exemplary embodiments with reference to the attached drawings.

### BRIEF DESCRIPTION OF DRAWINGS

FIG. 1 is a graph representing the change in the atom ratio of K and Si (K/Si) as a function of the distance from the surface in the direction of depth of the phase-separated glass of Example 1.

FIG. 2A is an electron micrograph of a fracture cross-section of the porous glass prepared in Example 1.

FIG. 2B is another electron micrograph of a fracture cross-section of the porous glass prepared in Example 1.

FIG. 2C is still another electron micrograph of a fracture cross-section of the porous glass prepared in Example 1.

FIG. 3A is an electron micrograph of a fracture cross-section of the porous glass prepared in Comparative Example 1.

FIG. 3B is another electron microscopic photograph of a fracture cross-section of the porous glass prepared in Comparative Example 1.

### DESCRIPTION OF EMBODIMENTS

Now, preferred embodiments of the present invention will be described below.

The present invention is made to cope with the above-identified problems and provides a method of manufacturing a porous silica glass having a porous skeletal structure that varies from the surface in the direction of depth.

In a first aspect of the present invention, there is provided a method of manufacturing a porous glass including: a step of bringing one or more than one ion species selected from silver ion, potassium ion and lithium ion into contact with a matrix glass containing borosilicate glass as main ingredient and heating the matrix glass to form a glass body having an ion concentration distribution with a concentration of the one or more than one ion species decreasing as a function of a distance from a surface in a direction of depth; a step of heating and phase-separating the glass body to form a phase-separated glass; and a step of etching the phase-separated glass to form a porous glass having a porosity decreasing as the function of the distance from the surface in the direction of depth.

In a second aspect of the present invention, there is provided a method of manufacturing a porous glass including: a step of bringing one or more than one ion species selected from silver ion, potassium ion and lithium ion into contact with a matrix glass containing borosilicate glass as main ingredient and heating the matrix glass to form an ion concentration distribution with a concentration of the one or more than one ion species decreasing as a function of a distance from a surface in a direction of depth and to form a phase-separated glass by phase separating; and a step of etching the phase-separated glass to form a porous glass having a porosity decreasing as the function of the distance from the surface in the direction of depth.

More specifically, a method of manufacturing a porous glass according to the present invention induces a manifestation of phase separation that varies in the direction of depth from the surface within a range from the surface of the glass containing borosilicate glass as main ingredient to a depth of several hundred μm by a phase separation process, making the glass composition vary stepwise by means of ion exchange. Then, a porous silica glass can be prepared with its porous structure made to vary from the surface in the direction of depth, particularly such that the porosity decreases as a function of the distance from the surface in the direction of depth by removing the non-silica-rich phase of the glass subjected to the phase separation process by etching.

Phase-separable borosilicate glass can be used as matrix glass for the present invention. Borosilicate glass is amorphous and contains silica, boron oxide and oxide having sodium as main ingredients. Generally, borosilicate glass is expressed in term of weight ratio reduced to silica (SiO₂), boron oxide (B₂O₃) and alkali metal oxide. The alkali metal oxide is typically sodium oxide (Na₂O).

Now, “phase separation” will be described below by way of an instance where borosilicate glass that contains silicon oxide, boron oxide and oxide having alkali metal is employed as glass body. “Phase separation” refers to separation of a phase containing the oxide having the alkali metal and the boron oxide more than the composition before the phase separation (non-silica rich phase) and a phase containing the oxide having the alkali metal and the boron oxide less than the composition before the phase separation (silica-rich phase) with structures of a scale of several nanometers.

Borosilicate glass having a specific composition brings a phase separation phenomenon of being separated into a silicate phase containing silica as main ingredient and a phase containing boron oxide and alkali metal oxide as main ingredients when heat is applied. Examples of borosilicate glass that gives rise to phase separation include SiO₂ (55 to 80 wt %) —B₂O₃—Na₂O—(Al₂O₃)-based glass, SiO₂ (35 to 55 wt %) —B₂O₃—Na₂O-based glass, SiO₂—B₂O₃—CaO—Na₂O—Al₂O₃-based glass, SiO₂—B₂O₃—Na₂O—RO (R: alkaline earth metal, e.g., Zn)-based glass and SiO₂—B₂O₃—CaO—MgO—Na₂O—Al₂O₃—TiO₂(TiO₂ being up to 49.2 mol %).

According to the present invention, firstly a step of forming a glass body (a stacked body of a matrix glass and a film containing ion species) having an ion concentration distribution where the concentration of the ion species decreases as a function of the distance from the surface in the direction of depth is executed by bringing the ion species into contact with a matrix glass containing borosilicate glass as main ingredient and heating the matrix glass.

The manifestation of phase separation in the next phase separation process can be made to locally vary by forming such an ion concentration distribution and making the composition in glass body vary from the surface in the direction of depth.

As a method of forming such an ion concentration distribution, ion species are brought into contact with a matrix glass and the matrix glass is heated. Techniques of brining ion species into contact with a matrix glass include a technique of immersing a matrix glass into a compound containing ion species and a technique of forming a film of a compound containing ion species on the surface of a matrix glass. The ion species existing on the surface of a matrix glass penetrate into the matrix glass as a result of diffusion or ion exchange to form an ion concentration distribution of the ion species.

Preferably, one or more than one ion species selected from silver ion, potassium ion and lithium ion are used. For using such ion species, as the compound including the ion species, nitrate, sulfate or chloride salt of silver ion and alkali metal ion are employed.

The range of forming such an ion concentration distribution is from the surface of the glass body to a distance of preferably not less than 500 μm and more preferably not less than 200 μm in the direction of depth for the purpose of the present invention.

The step of forming an ion concentration distribution of the ion species in the direction of depth is preferably executed by means of ion exchange for the purpose of the present invention. When an ion exchange process of borosilicate glass is executed, the ingredients of glass that are the target of ion exchange are mainly monovalent sodium ion (Na⁺). On the other hand, silver ion, potassium ion and lithium ion that are ion species to be used for the purpose of the present invention are stable in monovalent ion. Such ion species and sodium ion are exchanged on a one to one basis. The ion exchange conditions of ion species that are stable when they take a plurality of ionic state including a state of zero-valent, that of monovalent and that of divalent can hardly be controlled satisfactorily and hence such ion species are not suitable for the purpose of the present invention.

On the other hand, ion species that are introduced by means of ion exchange are metal ions having a valence same as the target of ion exchange. In the case of borosilicate glass, monovalent alkali metal ion and silver ion can be introduced with ease. The rate of the ion exchange is influenced to a large extent by the composition of borosilicate glass, the ion species introduced by the ion exchange, the salt to be used for the ion exchange and the process temperature. Generally, an ion exchange process using borosilicate glass is preferably conducted at heating temperatures between about 200° C. and about 550° C. The heating time is preferably within a range between 0.3 hours and 50 hours.

A manifestation of phase separation involving local structural variances is produced by making the composition of borosilicate glass vary stepwise from the surface in the direction of depth by means of ion exchange process and then conducting the phase separation process. The ion exchange process and the phase separation process may be conducted separately or continuously one after the other so long as the composition can be made to vary stepwise by means of ion exchange. When the ion exchange process and the phase separation heat treatment process are conducted separately, a process of removing the salts used for the ion exchange may be conducted between the above two processes. When the process temperature of the ion exchange process is found within the temperature range for inducing a manifestation of phase separation, the ion exchange process and the phase separation process may be induced simultaneously by holding a constant temperature for a long time without separating them because an ion exchange reaction proceeds relatively quickly if compared with the phase separation process.

How the composition of the glass body is made to vary from the surface of the glass body in the direction of depth by an ion exchange process can be observed typically by means of an energy dispersive X-ray analysis (EDX) of fracture cross-section.

Then, a step of heating the glass in which an ion concentration distribution of the ion species for phase separation is conducted.

A glass phase separation phenomenon is generally manifested as a result of forming a spinodal structure or a binodal structure by means of a phase separation process of holding the temperature around 500° C. to 700° C. The step of a phase separation process may be held to a constant temperature or, alternatively, a heat application process of maintaining a constant temperature rising rate or a temperature falling rate may be conducted there. The duration of the step of a phase separation process of holding the temperature around 500° C. to 700° C. is not shorter than 1 minute, preferably not shorter than 5 minutes.

The manner in which a phase separation phenomenon is manifested varies as a function of the glass composition, the temperature and the duration of holding the temperature so that the skeletal diameter, the pore diameter and the porosity at the time when a porous glass is obtained vary accordingly.

In a phase-separated borosilicate glass (phase-separated glass), the non-silica-rich phase formed mainly by boron oxide and alkali metal oxide is soluble to an acid solution. Therefore, the soluble phase of the non-silica-rich phase is eluted as a result of executing an acid treatment and a phase mainly formed by silica is left as skeleton to form a porous glass. This structure can be observed typically through a scanning electron microscope with ease.

The skeletal diameter, the pore diameter of the porous glass tend to increase and, at the same time, the porosity also tends to rise, the higher the phase separation process into phase separation temperature range and the longer the duration of holding the temperature. While the mechanism of this phenomenon has not been made clear to date, a theory proposed by the inventors of the present invention will be described below. Hundreds of hours need to be consumed until a state of equilibrium of the phase separation is reached at a given temperature. In the time range of a phase separation process that extends from several hours to several tens of hours, a state of equilibrium of the phase separation may be nearly reached and phase separation may become more remarkable, the longer the process time. In other words, the skeletal diameter and the pore diameter may become larger. Additionally, when the temperature is high, an effect of rising the reaction rate appears so that a state of equilibrium of the phase separation may be nearly reached and phase separation may become more remarkable, the higher the temperature under same process time. In other words, the skeletal diameter and the pore diameter may become larger. Furthermore, as the temperature is raised, the compositions of the two phases are slightly similar to each other in a state of equilibrium of phase separation. Thus, the silica content of the non-silica-rich phase may increase so that a relatively larger portion may be removed by acid etching to raise the porosity.

This theory explains that known phase separation processes of holding a temperature of inducing phase separation for a long time cannot give rise to a remarkable local change in the skeletal diameter, the pore diameter and the porosity in the inside of glass in the case of borosilicate glass having a uniform composition in the inside of glass.

Thus, the present invention can give rise to a remarkable local change in the skeletal diameter, the pore diameter and the porosity in the inside of glass containing borosilicate glass as main ingredient by forming an ion concentration distribution of ion species from the surface in the direction of depth.

For the purpose of the present invention, a step of bringing ion species into contact with a matrix glass containing borosilicate glass as main ingredient and maintaining the matrix glass at a temperature of inducing phase separation to form an ion concentration distribution of the ion species from the surface in the direction of depth and a step of executing a phase separation process may be conducted simultaneously. In other words, a phase-separated glass may be formed by bringing ion species into contact with a matrix glass containing borosilicate glass as main ingredient and heating the matrix glass to form an ion concentration distribution with the concentration of the ion species decreasing as a function of the distance from the surface in the direction of depth and at the same time conducting a phase separating. In this step, the heat treatment temperature is preferably from 500° C. to 700° C. Preferably, silver ion, potassium ion and lithium ion are employed as ion species.

Then, according to the present invention, a step of etching the phase-separated glass to obtain a porous glass in which the porous structure vary from the surface in the direction of depth, particularly of which a porosity decreases as a function of the distance from the surface in the direction of depth is conducted. Porosities are formed throughout a porous glass according to the present invention all the way from the surface to the inside.

The non-silica-rich phase is removed from the phase-separated glass by the etching using an acid solution. More specifically, the phase-separated glass is immersed in an acid solution in order to selectively elute the non-silica-rich phase in the glass. The acidic etching solution is hydrochloric acid, sulfuric acid, phosphoric acid or nitric acid and, the acid concentration of the etching solution is from 0.1 mol/L (0.1N) to 5 mol/L (5N), preferably from 0.5 mol/L (0.5N) to 2 mol/L (2N).

A silica layer that obstructs the etching can be formed on the surface of the phase-separated glass about several hundred nanometers depending on the glass composition. However, the surface silica layer can be removed by polishing or by an alkali treatment.

There can be instances where silica gel deposits on the silica skeleton depending on the glass composition. If necessary, a multi-stage etching technique that employs acidic etching solutions of different acidities or water can be used. The etching temperature may be between room temperature and 95° C. Also, if necessary, an ultrasonic wave may be applied during the etching process.

After the immersion process using an acid solution, an operation of rinsing the obtained porous glass with water is normally conducted for the purpose of removing the remaining soluble layer without eluting and the acid adhering to the porous glass.

The porous structure, more specifically how the skeletal diameter, the pore diameter and the porosity of the porous structure are made to vary from the surface in the direction of depth, of the glass obtained after completing the etching process can be observed typically by observing a fracture cross-section of the glass through an SEM.

A porous glass according to the present invention can be used for optical elements. Since the porous glass structure can be broadly controlled, the porous glass can be expected to find applications as optical elements including optical lenses for imaging, observation, projection, and scanning optical systems and deflector plates for display apparatus. When the porous glass is to be employed as an optical element and the glass surface layer section is to be disposed at the light incident place side relative to the glass inside, the present invention can provide a low reflectance optical element.

The porous glass can be used as part of an optical element to be arranged in an imaging apparatus (e.g., a digital camera or a digital video camera) having an imaging element disposed in a cabinet. Thus, the present invention can provide a method of manufacturing an imaging apparatus in which a porous glass to be used for an optical element is manufactured by the above-described method.

### Examples

Now, the present invention will be described further by way of examples. Note, however, the present invention is by no means limited by the examples.

Matrix glasses were prepared with a composition that can give rise to phase separation so as to be used in examples and in comparative examples of the present invention. The source compounds include silica powder (SiO₂), boron oxide (B₂O₃) and sodium carbonate (Na₂CO₃) as well as alumina (Al₂O₃). The ratio of the composition of compounds is SiO₂: 59 wt %, B₂O₃: 30.5 wt %, Na₂CO₃: 9 wt % and Al₂O₃: 1.5 wt %. The compounds were mixed and the mixed powder was put into a platinum crucible and molten at 1,500° C. for 24 hours. Subsequently, the glass temperature of the melt was lowered to 1,300° C. and the melt was poured into a graphite mold. After cooling the melt in air for 20 minutes, the obtained borosilicate glass block was cut to a piece 40 mm×30 mm×11 mm and the piece was polished at the opposite surfaces to produce mirror surfaces.

### Example 1

A piece of 15 mm×15 mm×11 mm was cut out from the matrix glass and put into a platinum crucible with 15 g of potassium nitrate. The piece of matrix glass was then immersed in powdery potassium nitrate. Then, the piece of matrix glass was subjected to an ion exchange process at a predetermined temperature for a predetermined period of time as represented in Table 1 (first heat treatment step). Thereafter, a phase separation process is conducted at a predetermined temperature for a predetermined time period (second heat treatment step).

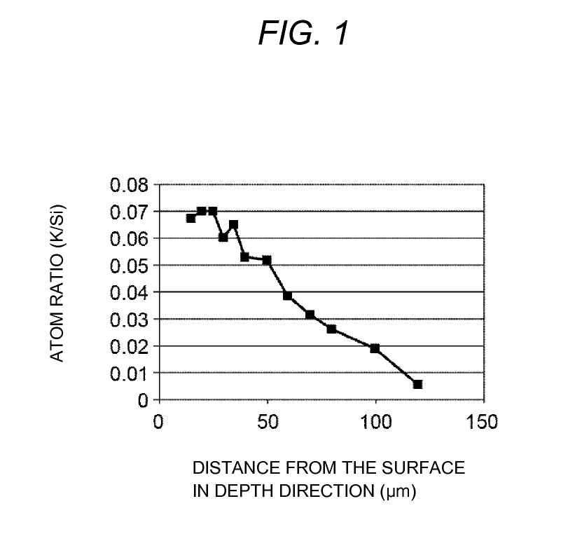

The glass sample obtained after the phase separation process was subjected to a composition analysis at a fracture cross-section by way of EDX. As a result of observation, the concentration distribution of potassium was found to be such that potassium was diffused with its concentration decreasing stepwise from the glass surface to a depth of 120 μm. FIG. 1 illustrates how the atom ratio of K and Si (K/Si) was made to vary from the glass surface in the direction of depth.

As a result of measuring the concentration distribution of sodium contained in the glass, the sodium concentration was found to be increasing stepwise from the glass surface to a depth of 120 μm but held to a constant level in the deeper part.

The glass sample obtained after the phase separation process was subjected to an etching process, using an acid solution. 50 g of 1 mol/L nitric acid was employed for the acid solution. Nitric acid was put into a polypropylene-made container, which was preliminarily heated to 80° C. in an oven. Then, the glass sample was suspended by a platinum wire and put into a central part of the solution. Then, the polypropylene container was closed with a lid and left at 80° C. for 24 hours. After the end of the treatment by nitric acid, the glass sample was put into water at 80° C. and rinsed with water.

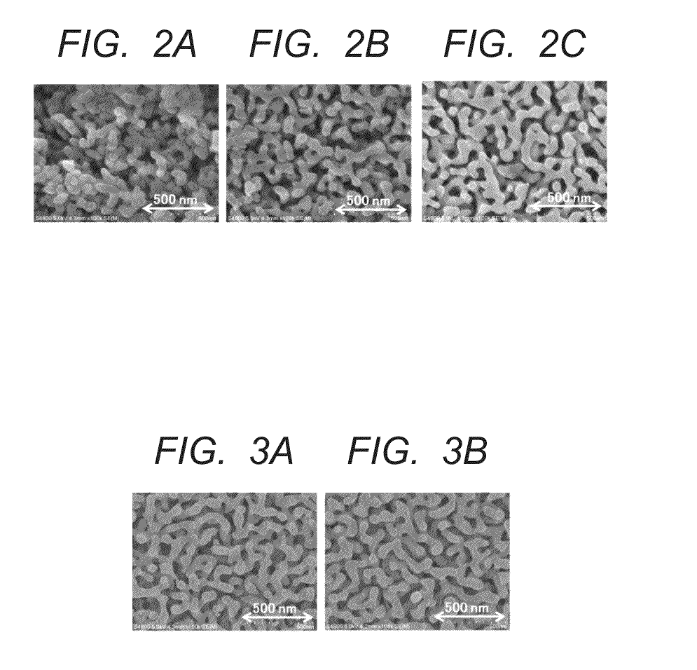

That the glass sample had turned to porous glass was observed through an SEM. FIGS. 2A to 2C illustrate electron micrographs of fracture cross-sections of the porous glass prepared in Example 1. FIG. 2A illustrates a fracture cross-section that is about 10 μm deep from the surface and FIG. 2B illustrates a fracture cross-section that is about 100 μm deep from the surface, while FIG. 2C illustrates a fracture cross-section that is about 500 μm deep from the surface. The SEM observations of the fracture cross-sections proved that both the skeletal diameter and the porosity of the porous glass were made to vary stepwise from the surface in the direction of depth.

### Example 2

A piece of 15 mm×15 mm×11 mm was cut out from the matrix glass and put into a platinum crucible with 15 g of silver nitrate. Then, the piece of matrix glass was subjected to an ion exchange process at a predetermined temperature for a predetermined period of time as represented in Table 1. Thereafter, a phase separation process is conducted at a predetermined temperature for a predetermined time period.

The glass sample obtained after the phase separation process was subjected to a composition analysis at a fracture cross-section by way of EDX. It was observed that silver was diffused with its concentration decreasing stepwise from the surface to a depth of 100 μm.

The glass sample obtained after the phase separation process was subjected to an etching process, using an acid solution as in Example 1. That the glass sample had turned to porous glass was observed through an SEM. The SEM observations of the fracture cross-sections proved that both the skeletal diameter and the porosity of the porous glass were made to vary stepwise from the surface in the direction of depth.

### Example 3

A piece of 15 mm×15 mm×11 mm was cut out from the matrix glass and put into a platinum crucible with 15 g of lithium nitrate. Then, the piece of matrix glass was subjected to an ion exchange process at a predetermined temperature for a predetermined period of time as represented in Table 1. Thereafter, a phase separation process is conducted at a predetermined temperature for a predetermined time period.

The glass sample obtained after the phase separation process was subjected to a composition analysis at a fracture cross-section by way of EDX. The concentration distribution of sodium was observed because lithium is a light element and could not be observed. As a result of observation, the sodium concentration was found to be increasing stepwise from the surface to a depth of 80 μm but held to a constant level in the deeper part. Thus, conceivably, lithium had been exchanged with sodium from the surface to a depth of 80 μm.

The glass sample obtained after the phase separation process was subjected to an etching process, using an acid solution as in Example 1. That the glass sample had turned to porous glass was observed through an SEM. The SEM observations of the fracture cross-sections proved that both the skeletal diameter and the porosity of the porous glass were made to vary stepwise from the surface in the direction of depth.

### Example 4

A piece of 15 mm×15 mm×11 mm was cut out from the matrix glass and put into a platinum crucible with 7 g of sodium nitrate and 7 g of silver nitrate. Then, the piece of matrix glass was subjected to an ion exchange process and a phase separation process simultaneously at predetermined temperatures for a predetermined period of time as represented in Table 1.

The glass sample obtained after the phase separation process was subjected to a composition analysis at a fracture cross-section by way of EDX. It was observed that silver was diffused with its concentration decreasing stepwise from the surface to a depth of 60 μm.

The glass sample obtained after the phase separation process was subjected to an etching process, using an acid solution as in Example 1. That the glass sample had turned to porous glass was observed through an SEM. The SEM observations of the fracture cross-sections proved that both the skeletal diameter and the porosity of the porous glass were made to vary stepwise from the surface in the direction of depth.

### Comparative Example 1

The matrix glass of Example 1 was also used in this comparative example. A piece of 15 mm×15 mm×11 mm was cut out from the matrix glass and subjected only to a phase separation process at a predetermined temperature for a predetermined time period as represented in Table 1.

The glass sample obtained after the phase separation process was subjected to an etching process, using an acid solution as in Example 1. That the glass sample had turned to porous glass was observed through an SEM. FIGS. 3A and 3B illustrate electron micrographs of fracture cross-sections of the porous glass prepared in Comparative Example 1. FIG. 3A illustrates a fracture cross-section that is about 10 μm deep from the surface and FIG. 3B illustrates a fracture cross-section that is about 500 μm deep from the surface. As a result of the SEM observations of the fracture cross-sections, that neither the skeletal diameter nor the porosity of the porous glass had been made to vary at the surface and at a deep part was proved.

### Comparative Example 2

The matrix glass of Example 1 was also used in this comparative example. A piece of 15 mm×15 mm×11 mm was cut out from the matrix glass and subjected only to a phase separation process at a predetermined temperature for a predetermined time period as represented in Table 1. Thereafter, the glass sample was put into a platinum crucible with 15 g of silver nitrate and subjected to an ion exchange process at a predetermined temperature for a predetermined period of time as represented in Table 1.

The glass sample obtained after the phase separation process was subjected to an etching process, using an acid solution as in Example 1. That the glass sample had turned to porous glass was observed through an SEM. However, as a result of the SEM observations of the fracture cross-sections, that neither the skeletal diameter nor the porosity of the porous glass had been made to vary at the surface and at a deep part was proved.

TABLE 1

| | | first heat treatment step | | | second heat treatment step | | |
|---|---|---|---|---|---|---|---|
| | ion | | average | step | | average | step |
| | exchange | | temperature | duration | | temperature | duration |
| sample | salt | process | (° C.) | (hr) | process | (° C.) | (hr) |
| Example 1 | KNO₃ | ion | 450 | 25 | phase | 600 | 50 |
| | | exchange | | | separation | | |
| Example 2 | AgNO₃ | ion | 350 | 50 | phase | 600 | 50 |
| | | exchange | | | separation | | |
| Example 3 | LiNO₃ | ion | 300 | 0.5 | phase | 600 | 50 |
| | | exchange | | | separation | | |
| Example 4 | AgNO₃ + | ion | 540 | 50 | | | |
| | NaNO₃ | exchange + | | | | | |
| | | phase | | | | | |
| | | separation | | | | | |
| Comp. | — | phase | 600 | 50 | | | |
| Ex. 1 | | separation | | | | | |
| Comp. | AgNO₃ | phase | 600 | 50 | ion | 350 | 50 |
| Ex. 2 | | separation | | | exchange | | |

### INDUSTRIAL APPLICABILITY

A method of manufacturing a porous glass according to the present invention can make a porous structure to vary stepwise from the surface of silica glass in the direction of depth and hence a porous glass manufactured by the method can find a broad scope of application in the field of optical elements.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2010-266327, filed Nov. 30, 2010, and No. 2011-253073, filed Nov. 18, 2011 which are hereby incorporated by reference herein in their entirety.

1. A method of manufacturing a porous glass used as optical element comprising:
a first step of bringing one or more than one ion species selected from silver ion, potassium ion and lithium ion into contact with a matrix glass containing borosilicate glass including SiO₂ (55 to 80 wt %), B₂O₃, Na₂O and Al₂O₃ and heating the matrix glass to form a glass body having an ion concentration distribution with a concentration of the one or more than one ion species decreasing as a function of a distance from a surface in a direction of depth;
a second step of heating and phase-separating the glass body to form a phase-separated glass; and
a third step of etching the phase-separated glass to form a porous glass having a porosity decreasing as the function of the distance from the surface in the direction of depth.

2. (canceled)

3. The method of manufacturing a porous glass according to claim 1, wherein the concentration of the ion species is made to decrease as the function of the distance from the surface in the direction of depth by ion exchange.

4. The method of manufacturing a porous glass according to claim 1, wherein a non-silica-rich phase is removed from the phase-separated glass by the etching using an acid solution.

5. (canceled)

6. A method of manufacturing a porous glass used as optical element comprising:
a first step of bringing one or more than one ion species selected from silver ion, potassium ion and lithium ion into contact with a matrix glass containing borosilicate glass including SiO₂ (35 to 55 wt %), B₂O₃ and Na₂O and heating the matrix glass to form a glass body having an ion concentration distribution with a concentration of the one or more than one ion species decreasing as a function of a distance from a surface in a direction of depth;
a second step of heating and phase-separating the glass body to form a phase-separated glass; and
a third step of etching the phase-separated glass to form a porous glass having a porosity decreasing as the function of the distance from the surface in the direction of depth.

7. (canceled)

8. The method of manufacturing a porous glass according to claim 1, wherein the second step is performed after the first step.

9. The method of manufacturing a porous glass according to claim 1, wherein the second step is performed concurrently with the first step.

10. The method of manufacturing a porous glass according to claim 1, wherein a range of the ion concentration distribution is not less than 500 μm from the surface in the direction of depth.

11. The method of manufacturing a porous glass according to claim 1, wherein the first step is performed at heating temperatures between 200° C. and 550° C.

12. The method of manufacturing a porous glass according to claim 1, wherein the first step is performed within a range between 0.3 hours and 50 hours.

13. The method of manufacturing a porous glass according to claim 1, wherein the first step is performed at heating temperatures between 200° C. and 550° C. and within a range between 0.3 hours and 50 hours.

14. The method of manufacturing a porous glass according to claim 6, wherein the second step is performed after the first step.

15. The method of manufacturing a porous glass according to claim 6, wherein the second step is performed concurrently with the first step.

16. The method of manufacturing a porous glass according to claim 6, wherein a range of the ion concentration distribution is not less than 500 μm from the surface in the direction of depth.

17. The method of manufacturing a porous glass according to claim 6, wherein the first step is performed at heating temperatures between 200° C. and 550° C.

18. The method of manufacturing a porous glass according to claim 6, wherein the first step is performed within a range between 0.3 hours and 50 hours.

19. The method of manufacturing a porous glass according to claim 6, wherein the first step is performed at heating temperatures between 200° C. and 550° C. and within a range between 0.3 hours and 50 hours.
